(19) United States
(12) Patent Application Publication
(10) Pub. No.: US 2013/0241943 A1
(43) Pub. Date: Sep. 19, 2013

(54) IMAGE PROCESSING SYSTEM, IMAGE PROCESSING APPARATUS, AND DISPLAY APPARATUS

(71) Applicant: Takao OKAMURA, Tokyo (JP)

(72) Inventor: Takao OKAMURA, Tokyo (JP)

(21) Appl. No.: 13/838,331

(22) Filed: Mar. 15, 2013

(30) Foreign Application Priority Data
Mar. 19, 2012 (JP) 2012-062702

(51) Int. Cl. G09G 5/00

(52) U.S. Cl. CPC G09G 5/005
USPC 345/520

(57) ABSTRACT

An image processing system includes a display apparatus and an image processing apparatus that transmits image data to the display apparatus. The image processing apparatus includes a processing side memory unit that stores characteristic information of the image processing apparatus and the display apparatus, an image conversion process unit that converts input image data into converted image data that is optimized according to a display characteristic of the display apparatus based on the characteristic information, and a processing side transmission process unit that transmits the converted image data to the display apparatus. The display apparatus includes a display side reception process unit that receives the converted image data transmitted from the image processing apparatus, and an image display unit that displays the received image data.

### BACKGROUND OF THE INVENTION

1. Field of the Invention

The disclosures herein relate to an image processing system that includes an image processing apparatus that is connected to a display apparatus such as a projector to display an image.

2. Description of the Related Art

As a generally known method for displaying an image on a display apparatus such as a projector, an information processing apparatus such as a personal computer is connected to the projector so that a display screen of a presentation slide displayed at the information processing apparatus may be generated and displayed by the projector. However, in such a display method, both the display apparatus and the information processing apparatus are used as a set so that both apparatuses have to be brought to the location where a presentation is to be conducted which may be quite burdensome. In some cases, the information processing apparatus may be brought to a location where a presentation is to be conducted and the information processing apparatus may be connected to the display apparatus provided at this location. However, in such case, there may be difficulties in establishing connection between the information processing apparatus and the display apparatus, and even if connection is established, settings may have to be adjusted at the information processing apparatus to enable display by the display apparatus.

Also, another display method using a display apparatus such as a projector is known that involves connecting the display apparatus to an image processing apparatus such as a copier, a printer, or a facsimile machine rather than an information processing apparatus. For example, Japanese Laid-Open Patent Publication No. 2011-118099 (Patent Document 1) discloses an image processing apparatus that prompts a projector to display document data by analyzing a characteristic of document data requested by a projector; creating display data for displaying the document data at the projector and determining a control command for controlling the projector based on the characteristic analysis result; and combining the generated display data and the determined control command and transmitting the combined data as presentation data to the projector. Also, Japanese Laid-Open Patent Publication No. 2011-034460 (Patent Document 2) discloses an image processing cooperation system that enables image display by a projector by designating a projector or a printer as an output destination of output data. Japanese Laid-Open Patent Publication No. 2003-348269 (Patent Document 3) discloses an image processing apparatus that scans a document and supplies the scanned document image data to a projector to enable image display by the projector.

FIG. 1 illustrates an exemplary method of displaying an image of a paper document by a projector. In the illustrated method, an image processing apparatus 300 such as a digital multifunction printer having a document scanning function is used to scan a paper document P to obtain image data M of the paper document P. Then, the scanned image data is transmitted to an information processing apparatus 301 such as a personal computer via a communication network. The information processing apparatus 301 is connected to a projector 302 via a communication cable, and the information processing apparatus 301 is operated so that the received image data M may be forwarded to the projector 302. Then, the projector 302 projects the image data M on a screen S to display the image data M. Also, the image data M may be written on a removable storage medium 303 such as a USB memory or a flash memory that is connected to the image processing apparatus 300, and the storage medium 303 may then be connected to the projector 302 to display the image data M.

Also, the information processing apparatus 301 may gain access to document data stored in the image processing apparatus 300 and download the document data. Then, the information processing apparatus 301 may forward the downloaded document data to the projector 302 so that the document data may be displayed by the projector 302. Further, the document data stored in the image processing apparatus 300 may be output in the form of a paper document, and the paper document may be scanned in the manner described above. Then, the scanned image data may be transmitted to the projector 302 via the information processing apparatus 301 so the image data may be displayed by the projector 302.

However, in the case where the projector displays image data that is generated by an apparatus other than the information processing apparatus, various problems may occur. FIG. 2 illustrates exemplary cases in which the projector fails to accurately display image data. In CASE 1, image display fails because the projector is only capable of displaying image data in JPEG format but image data in the TIFF format is input. In CASE 2, the projector fails to display image data in the correct orientation because the direction of the input image data does not match the display direction of the projector. In CASE 3, the projector fails to display the image data because the volume of the image data is greater than the projector memory capacity. In CASE 4, the projector only displays a portion of the image data because the image data size is greater than the projector screen size.

As described above, in the case of having a display apparatus such as a projector display image data generated by an apparatus other than an information processing apparatus such as a personal computer, the display apparatus may not be able to accurately display the image data as desired.

### SUMMARY OF THE INVENTION

According to one embodiment of the present invention, an image processing system includes a display apparatus and an image processing apparatus that transmits image data to the display apparatus. The image processing apparatus includes a processing side memory unit that stores characteristic information of the image processing apparatus and the display apparatus, an image conversion process unit that converts input image data into converted image data that is optimized according to a display characteristic of the display apparatus based on the characteristic information, and a processing side transmission process unit that transmits the converted image data to the display apparatus. The display apparatus includes a display side reception process unit that receives the converted image data transmitted from the image processing apparatus, and an image display unit that displays the received image data.

### BRIEF DESCRIPTION OF THE DRAWINGS

Other objects and further features of embodiments will be apparent from the following detailed description when read in conjunction with the accompanying drawings, in which:

FIG. 1 illustrates an exemplary method of displaying an image of a paper document by a projector;

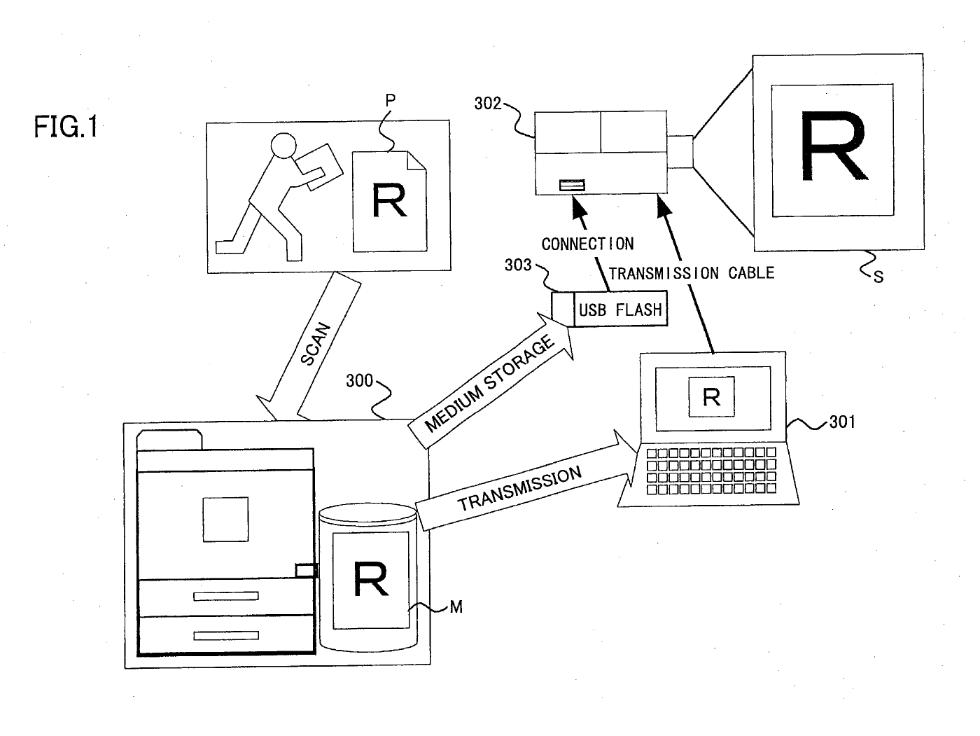

FIG. 2 illustrates exemplary cases in which the projector fails to accurately display image data;

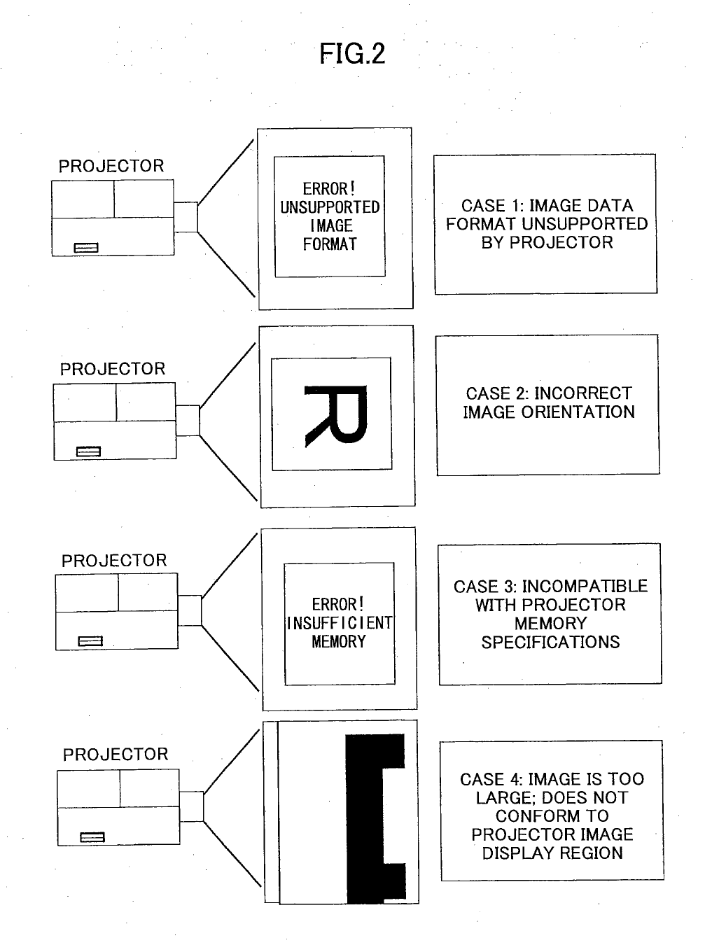

FIG. 3 illustrates a configuration of an image processing system according to an embodiment of the present invention;

FIG. 4 is a block diagram illustrating an exemplary hardware configuration of an image processing apparatus according to an embodiment of the present invention;

FIG. 5 is a block diagram illustrating an exemplary hardware configuration of a projector according to an embodiment of the present invention;

FIG. 6 is a block diagram illustrating an exemplary functional configuration of the image processing apparatus;

FIG. 7 is a block diagram illustrating an exemplary functional configuration of the projector;

FIG. 8 is a flowchart illustrating image display process operations performed by the image processing unit and the projector;

FIG. 9 is a flowchart illustrating an initialization process of the image processing apparatus;

FIG. 10 illustrates an exemplary initial setting screen for the image processing apparatus;

FIG. 11 is a flowchart illustrating exemplary process steps of an image conversion process performed by the image processing apparatus;

FIG. 12 illustrates an exemplary input image setting screen;

FIG. 13 illustrates an exemplary setting screen for manually establishing settings for an input image;

FIG. 14 is a flowchart illustrating exemplary process steps for establishing conversion settings in the image conversion process of FIG. 11;

FIG. 15 illustrates an exemplary case of performing a conversion setting optimization process based on the specification information of the image processing apparatus and the projector;

FIG. 16 illustrates an exemplary setting screen for establishing conversion settings;

FIG. 17 illustrates an exemplary display screen indicating conversion settings of a network-connected projector;

FIG. 18 illustrates an exemplary display screen indicating default conversion settings;

FIG. 19 illustrates an exemplary display screen indicating pre-registered conversion settings of a certain type;

FIG. 20 illustrates an exemplary display screen for manually setting up the various items of setting information;

FIG. 21 illustrates exemplary process steps of an image data re-conversion process;

FIG. 22 is a flowchart illustrating exemplary process steps of an editing process of the image conversion process of FIG. 11;

FIG. 23 illustrates an exemplary edit setting screen;

FIG. 24 is a flowchart illustrating exemplary process steps for of an image conversion process;

FIG. 25 is a flowchart illustrating exemplary process steps of an image transmission process;

FIG. 26 illustrates an exemplary case of transmitting image data one page at a time;

FIG. 27 illustrates an exemplary case of transmitting image data in document units;

FIG. 28 illustrates an exemplary case of transmitting image data of all documents;

FIG. 29 illustrates an exemplary case of transmitting image data according to the specification information such as memory capacity of the projector;

FIG. 30 illustrates an exemplary setting screen for selecting a stored document and transmitting image data of the selected document;

FIG. 31 is a flowchart illustrating exemplary process steps of an initialization process of the projector;

FIG. 32 illustrates an exemplary initial setting screen for the projector;

FIG. 33 is a flowchart illustrating exemplary process steps of a reception process of the projector; and

FIG. 34 is a sequence chart illustrating image display process operations between the image processing apparatus and the projector.

### DESCRIPTION OF THE PREFERRED EMBODIMENTS

According to an embodiment of the present invention, an image processing system is provided in which an image processing apparatus converts image data into converted image data that is optimized according to display characteristics of a display apparatus so that the display apparatus may accurately display the image data.

In the following, embodiments of the present invention are described with reference to the accompanying drawings.

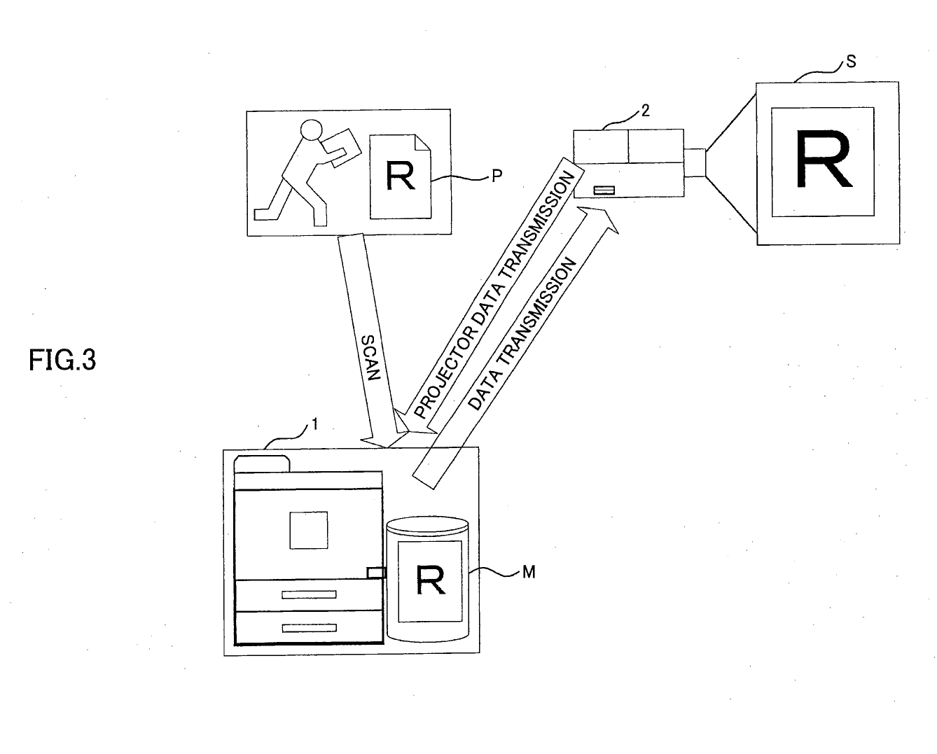

FIG. 3 illustrates a configuration of an image processing system according to an embodiment of the present invention. The illustrated image processing system includes an image processing apparatus 1 and a projector 2 as an embodiment of a display apparatus. The image processing apparatus 1 has a document scanning function (scanner) and is configured to scan a paper document P to be displayed by the projector 2 and store the scanned image data M. The image processing apparatus 1 can also store image data supplied from an external apparatus. The projector 2 displays an image by projecting the image data M supplied from the image processing apparatus 1 on a screen S. The image data from the image processing apparatus 1 may be transmitted through wired or wireless communication, for example. Alternatively, the image data stored in the image processing apparatus 1 may be written on a storage medium such as a USB memory, and the storage medium may be connected to the projector 2 to supply the image data to the projector 2. As described in detail below, the image processing apparatus 1 obtains characteristic information of the projector 2, and based on the obtained characteristic information, the image processing apparatus 1 performs an image conversion process to optimize image data according to the display characteristics of the projector 2. By supplying the converted image data to the projector 2, the image data may be accurately displayed by the projector 2.

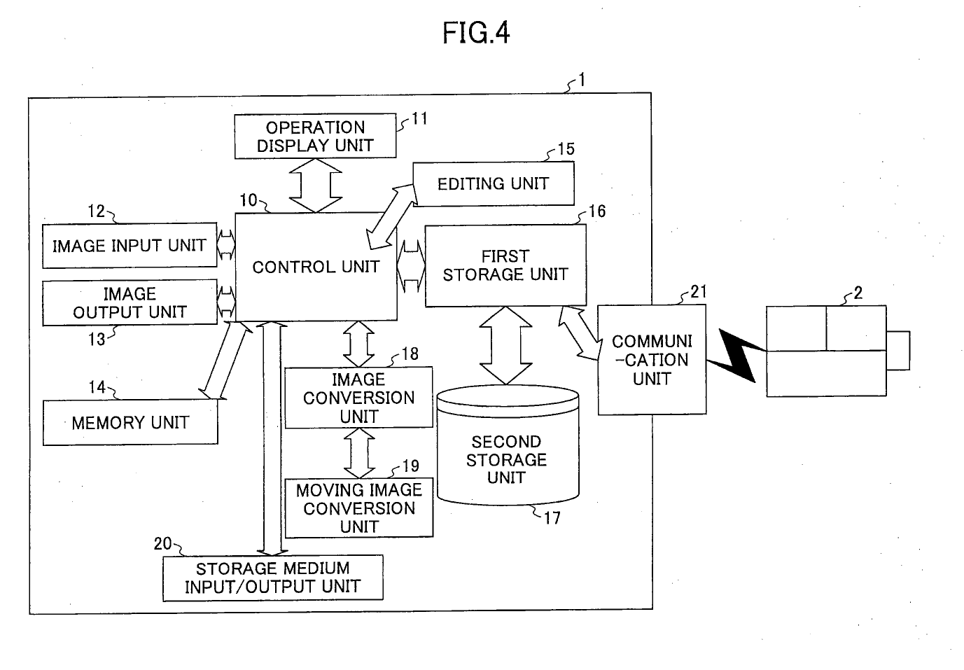

FIG. 4 is a block diagram illustrating an exemplary hardware configuration of the image processing apparatus 1. The image processing apparatus 1 includes a control unit 10 that controls overall apparatus operations; an operation display unit 11 including a display panel for displaying various items of information and a touch panel function for inputting operation data; an image input unit 12 that inputs image data through image scanning, an image output unit 13 that outputs image data to a medium such as paper, and a memory unit 14 that stores specification information such as characteristic information of the image processing apparatus 1 and specification information such as characteristic information of the projector 2 that is obtained from the projector 2. The image processing apparatus 1 further includes an editing unit 15 that performs image editing operations such as printing, stamping, rotating, scaling, and combining; a first storage unit 16 that stores image data input by the image input unit 12 and edited image data, and loads the stored image data to perform various processes thereon; a second storage unit 17 that stores the processed image data; an image conversion unit 18 that is capable of converting image data into a desired format, resolution, and color, and converting a color tone by changing parameter settings; a moving image conversion unit 19 that converts image data generated by the image conversion unit 18 into moving image data; a storage medium input/output unit 20 that is connected to a storage medium such as a USB memory or an SD card and performs data reading/writing operations; and a communication unit 21 that establishes communication with external apparatuses including the projector 2. For example, the communication unit 21 may exchange data and commands with an external apparatus via a IEEE 1394, a USB, or a LAN.

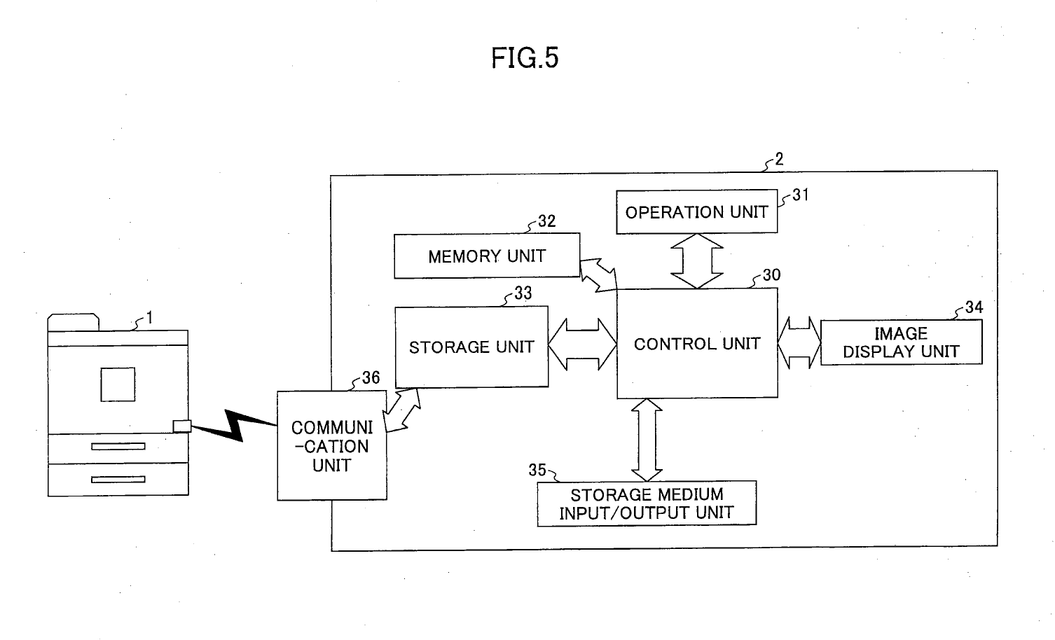

FIG. 5 is a block diagram illustrating an exemplary hardware configuration of the projector 2. The projector 2 includes a control unit 30 that controls overall apparatus operations, an operation unit 31 including a display panel for displaying various items of information and a touch panel function for inputting operation data. It is noted that the operation unit 31 may be operated using a setting screen displayed by an image display unit 34 as is necessary or desired. The projector 2 also includes a memory unit 32 that stores specification information such as characteristic information of the projector 2; a storage unit 33 that stores image data and loads the image data to perform various processes thereon; the image display unit 34 that loads the image data to be displayed and displays the image data; a storage medium input/output unit 35 that is connected to a storage medium such as a USB memory or an SD card and performs data reading/writing operation; a communication unit 36 that establishes communication with an external apparatus. For example, the communication unit 36 may exchange data and commands with an external apparatus via an IEEE 1394, a USB, a LAN, as RS-232C, an HDMI.

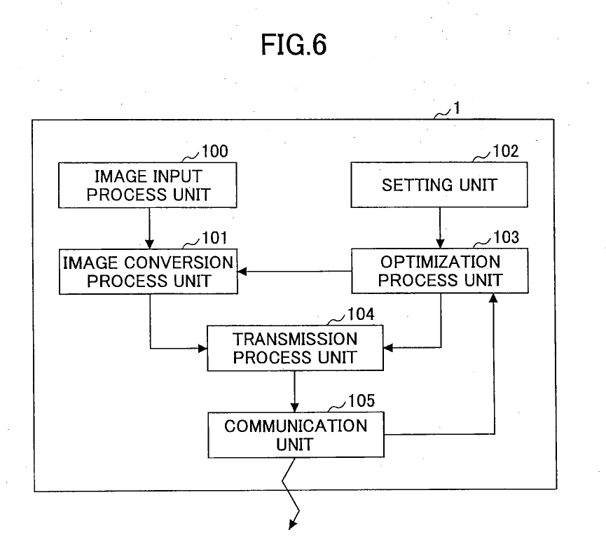

FIG. 6 is a block diagram illustrating an exemplary functional configuration of the image processing apparatus 1. The image processing apparatus 1 includes an image input process unit 100 that establishes input settings based on a change request from a user and performs image data input processes; and an image conversion process unit 101 the performs image conversion based on input image data from the image input process unit 100 and image conversion settings established by an optimization process unit 103; and a setting unit 102 that establishes data necessary for image conversion such as specification information including characteristic information of the image processing apparatus 1 and the projector 2. It is noted that the characteristic information of the projector 2 may be obtained from the projector 2 and registered in the image processing apparatus 1 beforehand. The image processing apparatus 1 also includes the optimization process unit 103 that establishes image conversion settings that are optimal for image display by the projector 2 based on the information established by the setting unit 102. For example, the optimization process unit 103 may establish image conversion settings so that the image size of image data may be adjusted according to the processing and memory capacity of the projector 2 or the image data may be optimized according to other display characteristics of the projector 2. The image processing apparatus 1 further includes a transmission process unit 104 that establishes a transmission setting for transmitting the processed image data to the projector 2. That is, the transmission process unit 104 selects whether to use a transmission setting of the image processing apparatus 1, a transmission setting of the projector 2, or a transmission setting established manually by a user. The image processing apparatus 1 also includes a communication unit 105 that exchanges data and commands with an external apparatus. For example, the communication unit 105 may transmit image data according to the transmission setting established by the transmission setting unit 104 or receive information such as specification information from the projector 2.

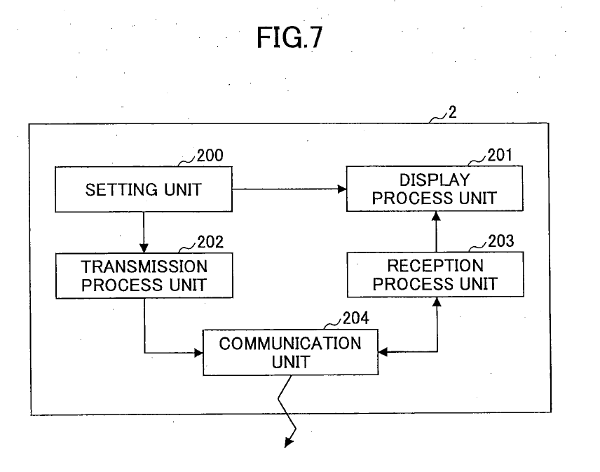

FIG. 7 is a block diagram illustrating an exemplary functional configuration of the projector 2. The projector 2 includes a setting unit 200 that establishes initial settings for image display operations and establishes settings based on a display request by a user; a display process unit 201 that displays image data based on the settings established by the setting unit 200 and image data received by an reception process unit 203; a transmission process unit 202 that transmits information such as display settings and characteristic information of the projector 2 to the image processing unit 1; and the reception process unit 203 that establishes an image data reception method (reception setting) based on the display settings. For example, the reception process unit 203 may select whether to receive image data one page at a time or receive the image data all at once, and receive the image data according to the selected method. The projector 2 also includes a communication unit 204 that exchanges data and commands with an external apparatus and transmits/receives data based on the processes performed by the transmission process unit 202 and the reception process unit 203.

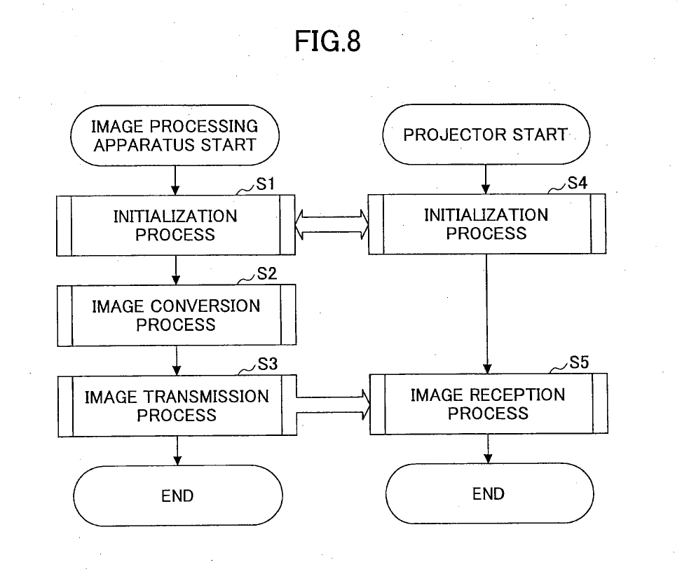

FIG. 8 is a flowchart illustrating image display process operations performed by the image processing unit 1 and the projector 2. First, an initialization process is performed at the image processing apparatus 1 (S1), and a corresponding initialization process is performed at the projector 2 (S4). During the initialization processes, characteristic information such as specification information and display setting information are exchanged between the image processing apparatus 1 and the projector 2. At the image processing apparatus 1, an image data conversion process is performed after the initialization process so that image data that is optimized according to the display characteristics of the projector 2 may be generated (S2). Then, an image data transmission process is performed for transmitting the converted image data from the image processing apparatus 1 (S3). In turn, an image data reception process is performed at the projector 2 for receiving the transmitted image data (S5).

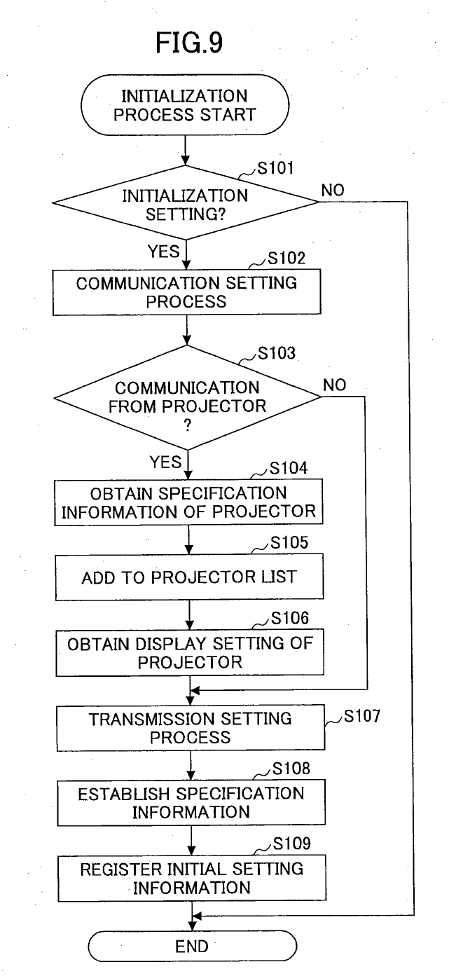

FIG. 9 is a flowchart illustrating the initialization process of the image processing apparatus 1. First, a determination is made as to whether initialization setting process is to be performed (S101). In the case of performing the initialization process (S101, YES), first, a communication setting process is performed (S102). In the communication setting process, the communication status between the image processing apparatus 1 and an external apparatus that is connected to a communication network is determined. Then, the communication status with the projector 2 is determined (S103). If communication can be established between the image processing apparatus 1 and the projector 2 (S103, YES), specification information of the projector 2 is obtained (S104). Then, the obtained specification information of the projector 2 is added to a projector list (S105). Then, display setting information of the projector 2 is obtained (S106), and a transmission setting process according to the obtained display setting information is performed (S107). In the transmission setting process, a determination is made as to whether image data are to be transmitted in one page units, document units, or all documents at once. Then, specification information of the image processing apparatus 1 is established (S108), and the initialization setting information is registered (S109). If no initialization setting process is to be performed (S101, NO), the process is simply ended. Also, if communication with the projector 2 cannot be established (S103, NO), the process proceeds to step S107 and the transmission setting process is performed.

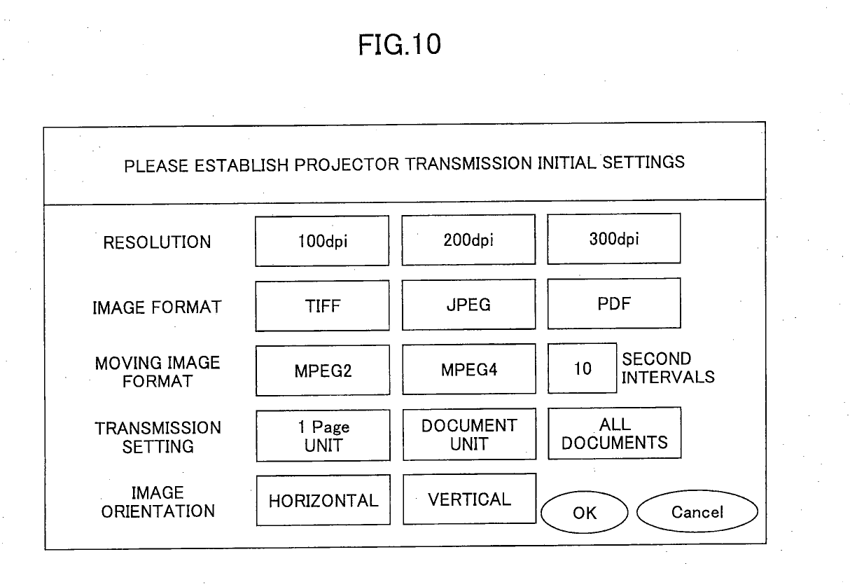

FIG. 10 illustrates an exemplary initial setting screen for the image processing apparatus 1. The illustrated initial setting screen prompts selection of initial settings for image data transmission to the projector 2 including the resolution, the image format, the moving image format, the transmission setting, and the image orientation. The initial setting information established via the initial setting screen become default values to be used in subsequent image data conversion processes. It is noted that in selecting the moving image data format, a screen display time interval may be designated so that the image data may be converted into moving image data for a slide show, for example.

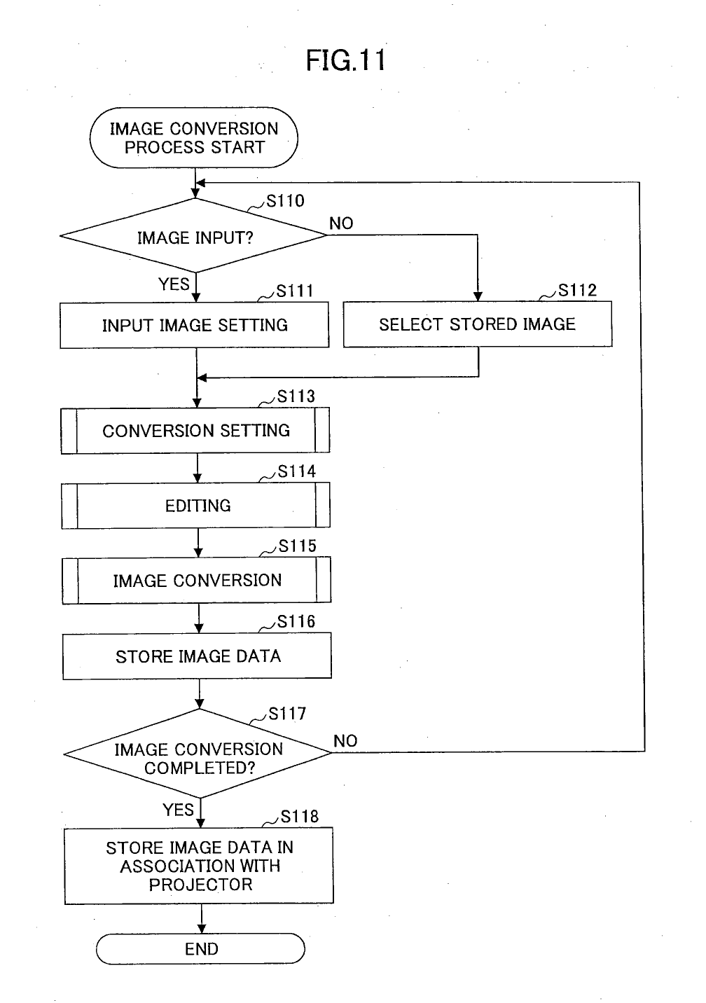

FIG. 11 is a flowchart illustrating process steps of an image conversion process performed by the image processing apparatus 1.

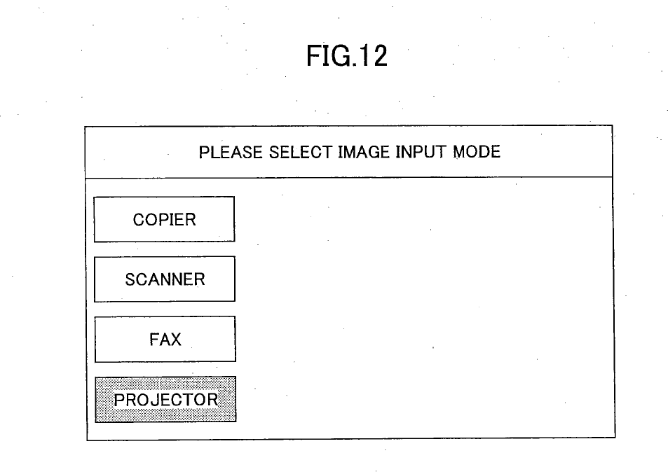

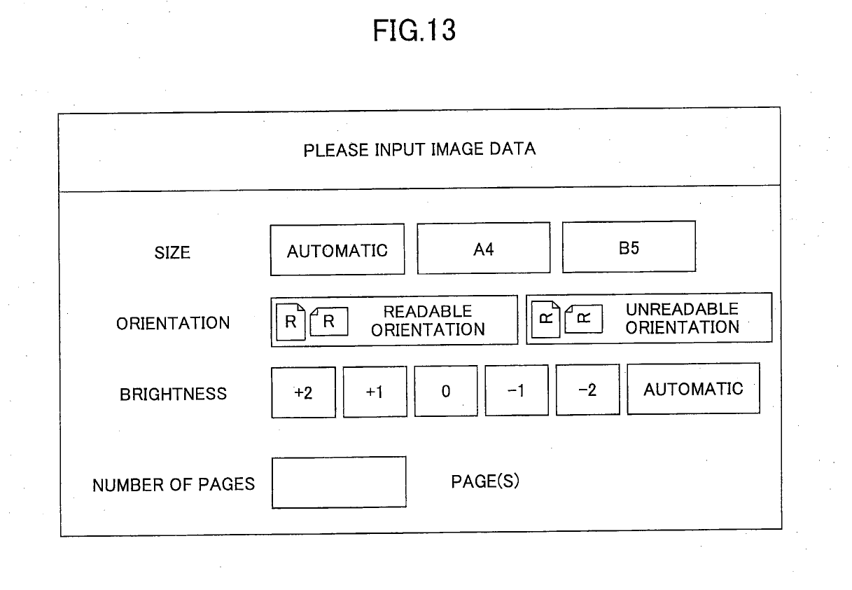

First, a determination is made as to whether an image data input process has been performed (S110). If image data is input (S110, YES), an input image setting process is performed (S111). In this process, settings relating to the input mode of the image data such as paper size and full-color or black & white are established. FIG. 12 illustrates an exemplary input image setting screen that enables selection of a copier, a scanner, a fax, or a projector as the image input manner (input mode). In this example, the projector is selected. FIG. 13 illustrates an exemplary setting screen for manually establishing settings for an input image. In the illustrated example, the image data size, the orientation, the brightness, and the page number may be designated. It is noted that in a case where an optimization process is to be performed, the brightness setting must be set to “automatic.” The setting information established via the setting screen is stored in association with the image data and used upon performing an image conversion process on the image data.

Referring back to FIG. 11, if there is no input image data (S110, NO), stored image data is selected (S112) and conversion settings are established for the image data which is described in detail below (S113). After establishing the conversion settings, an editing process (S114), and image conversion (S115) are performed, the details of which are described below. After image conversion, the converted image data is stored (S116) and a determination is made as to whether image conversion processes have been performed on all of the image data (S117). If there is image data that has not yet been converted (S117, NO), the process goes back to step S110, and the next image data is processed in the manner described above. If it is determined that image conversion processes have been performed on all of the image data (S117, YES), the converted image data are stored as image data for the projector (S118), and the process is ended.

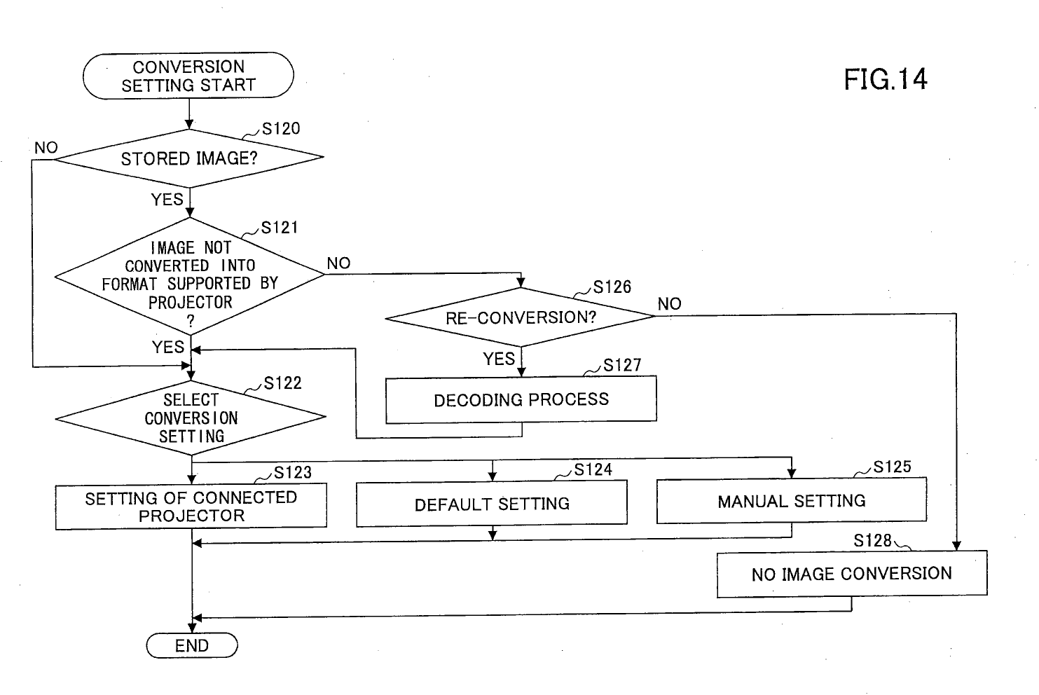

FIG. 14 is a flowchart illustrating exemplary process steps for establishing conversion settings in the image conversion process illustrated in FIG. 11.

First, a determination is made as to whether the image data subject to processing corresponds to stored image data (S120). If the image data corresponds to stored image data (S120, YES), a determination is made as to whether the image data is not yet converted for the projector (S121). If the image data has not yet been converted for the projector (S121, YES), a conversion setting is selected (S122). In the present example, a selection is made from conversion settings corresponding to the initial settings of the projector (S123), conversion settings corresponding to the initial settings of the image processing apparatus (default settings) (S124), or conversion settings manually set up by the user (S125). If the image data does not correspond to stored image data (S120, NO), the process proceeds to step S122 where conversion settings are established. In the case where the image data corresponds to converted image data for the projector (S121, NO), a determination is made as to whether re-conversion is to be performed on the image data (S126). If re-conversion is to be performed on the image data (S126, YES), a decoding process is performed for decoding the image data to pre-converted image data (S127), and the process proceeds to step S122 where conversion settings are established. If it is determined in step S126 that no re-conversion is to be performed (S126, NO), no image conversion process is to be performed on the image data (S128), and the process is ended.

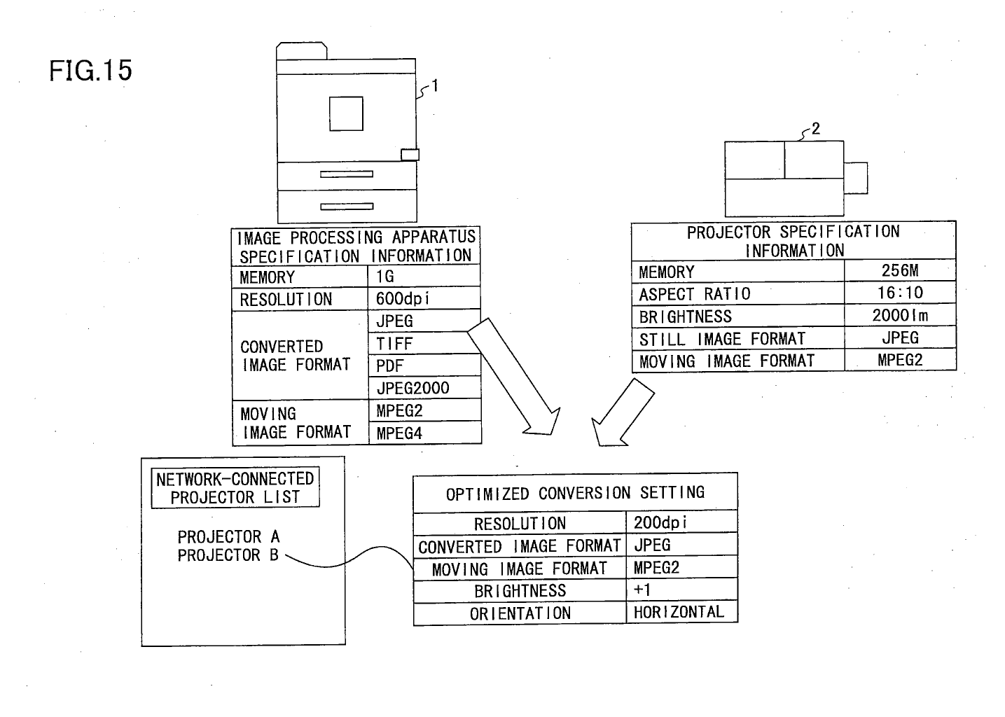

FIG. 15 illustrates an exemplary case of performing a conversion setting optimization process based on the specification information of the image processing apparatus 1 and the projector 2.

In the present example, the specification information of both the image processing apparatus 1 and the projector 2 are compared to establish optimal conversion settings. In the illustrated conversion setting optimization process, the resolution of the image data, the image format of the converted image data, the moving image format, the image brightness, and the image orientation are established. With regard to the resolution of the image data, the memory capacities of the image processing apparatus 1 and the projector 2 (i.e., 1G at the image processing apparatus 1; 256M at the projector 2) are compared and the resolution is established at 200 dpi. With regard to the image format and moving image format of the image data, the JPEG format and the MPEG 2 format that are supported by both the image processing apparatus 1 and the projector 2 are selected. The brightness of the image data is established based on the brightness setting of the projector 2. The orientation of the image data is established based on the aspect ratio of the projector 2. The optimized conversion settings generated in this manner are stored in association with a corresponding projector B included in a list of network-connected projectors.

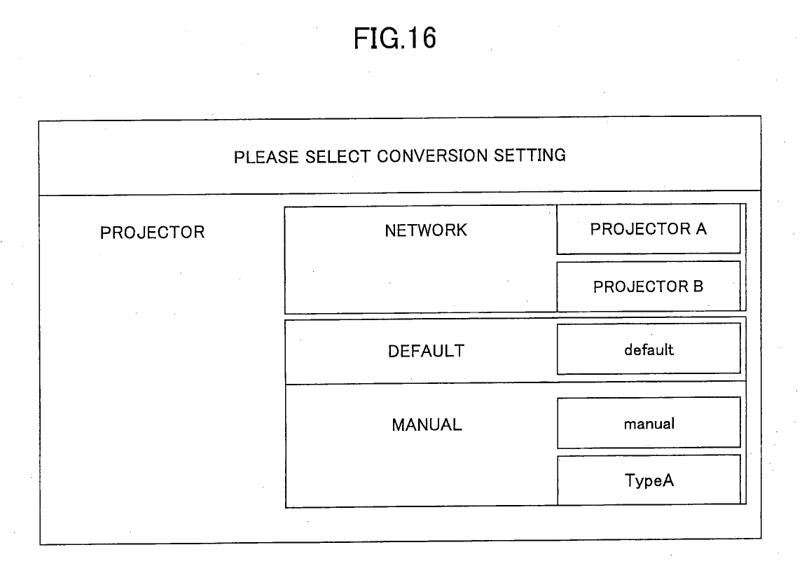

FIG. 16 illustrates an exemplary setting screen for establishing conversion settings. The illustrated setting screen is for establishing conversion settings for a projector, and enables selection of conversion settings from various options including the conversion settings of various projectors connected to the network, conversion settings based on default values of the image processing apparatus 1, manually established conversion settings, and pre-registered conversion settings of one or more types. For, example, in a case where the default conversion settings are selected, image conversion is performed based on the initial setting values of the image processing apparatus 1. In a case where manually established conversion settings are selected, the various items of setting information required for image conversion may be manually established.

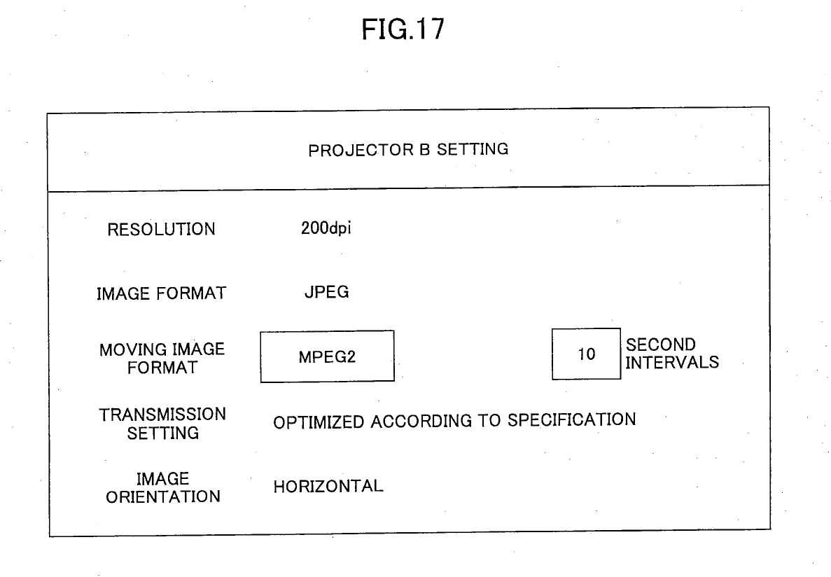

FIG. 17 illustrates an exemplary display screen indicating conversion settings of a projector connected to the network. The illustrated display screen indicates setting data of the optimized conversion settings generated in the manner described above, and enables selection of the moving image format.

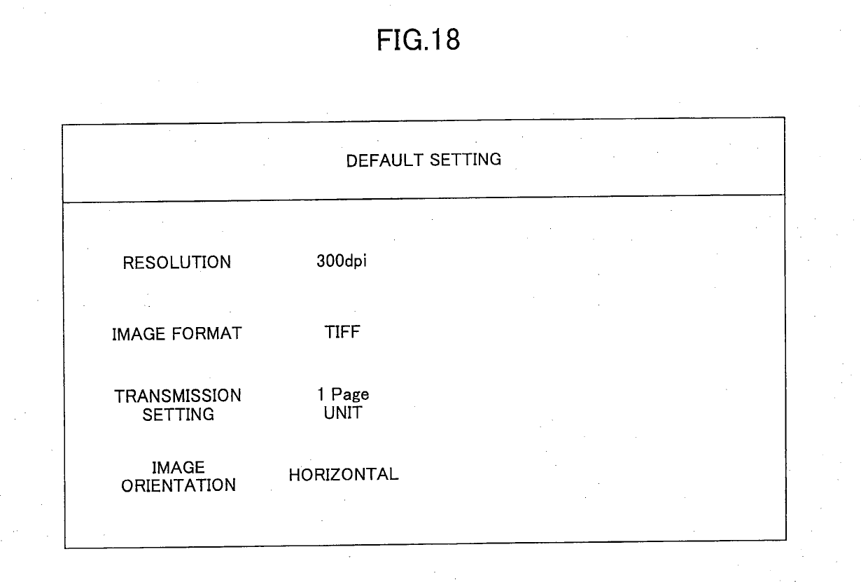

FIG. 18 illustrates an exemplary display screen indicating the default conversion settings. The illustrated display screen indicates setting data corresponding to the initial settings of the image processing apparatus 1.

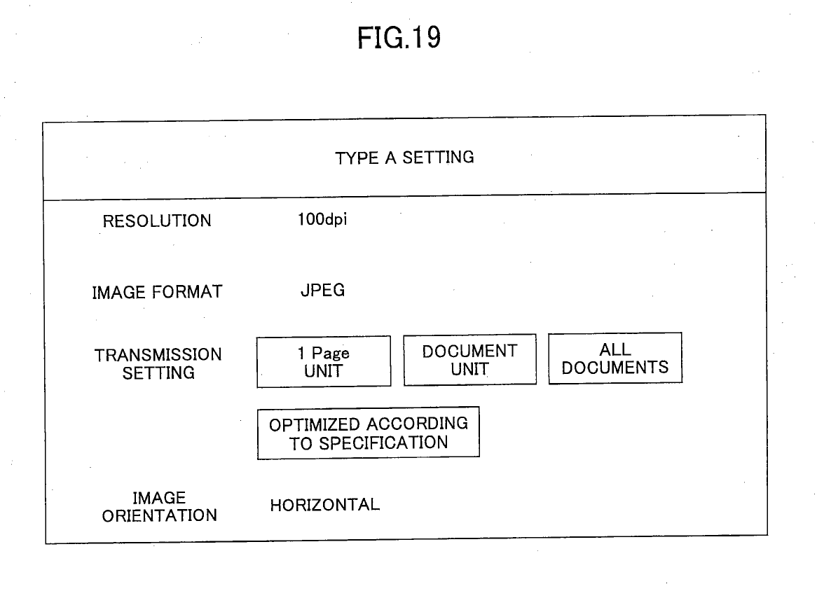

FIG. 19 illustrates an exemplary display screen indicating pre-registered conversion settings of a certain type. In the present example, different types of setting data for the projector are pre-registered in the image processing apparatus 1, and the illustrated display screen indicates the pre-registered setting data of Type A. It is noted that in the present example, the transmission setting is established manually according to the actual projector to which the converted image data is to be transmitted.

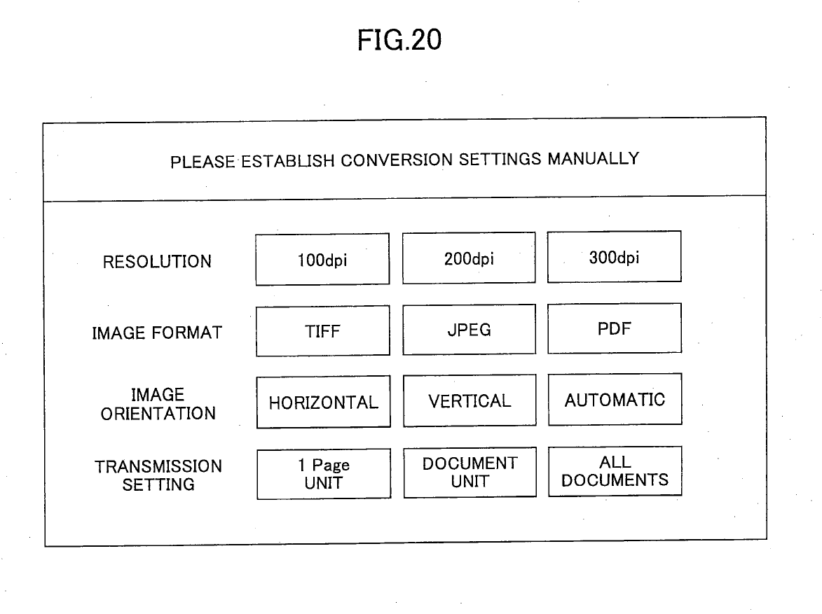

FIG. 20 illustrates an exemplary display screen for manually establishing the various items of setting information. In the illustrated display screen enables a user to manually establish the resolution, the image format, the image orientation, and the transmission setting for an input image. It is noted that in the case where the optimization process is to be performed, the setting data that is manually established may be readjusted to the optimized setting data.

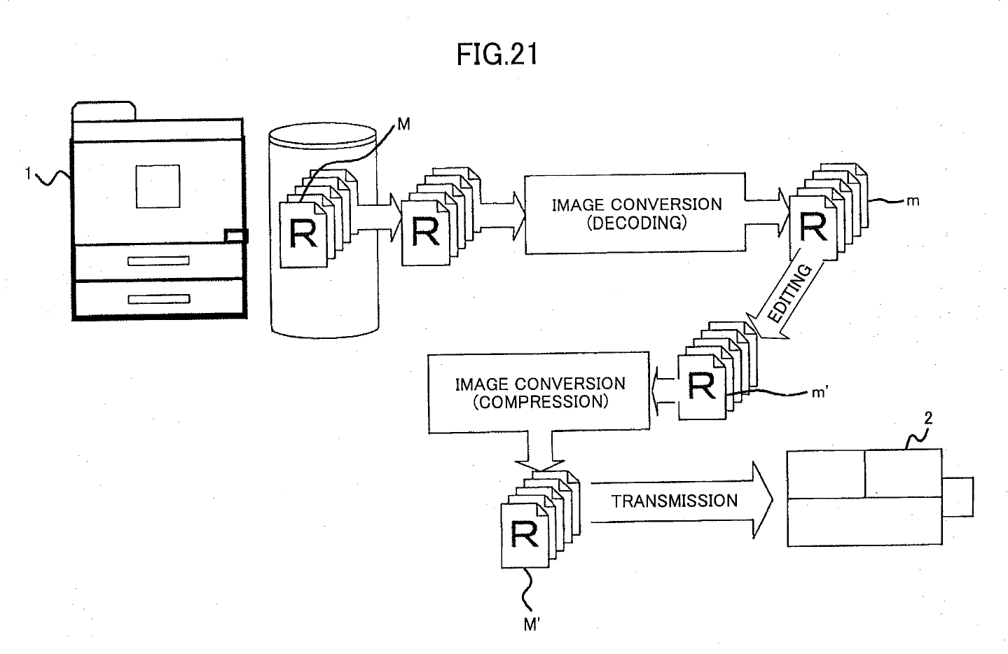

FIG. 21 illustrates exemplary process steps of an image data re-conversion process.

In the illustrated example, document data M for a projector is stored in the image processing apparatus 1 in the JPEG image format. In the case of performing a re-conversion process, the document data M is read out and decoded to restore the document data M back to pre-converted document data m. Then, an editing process such as rotation and/or scaling is performed on the document data m to obtain edited document data m′. Then, the document data m′ is compressed once again to generate document data M′ in the JPEG image format. The generated document data M′ is then transmitted to the projector 2. By performing the re-conversion process in the above-described manner, converted image data for a certain projector may be restored back to pre-converted image data and editing processes may be performed thereon to re-convert the image data for another projector, for example.

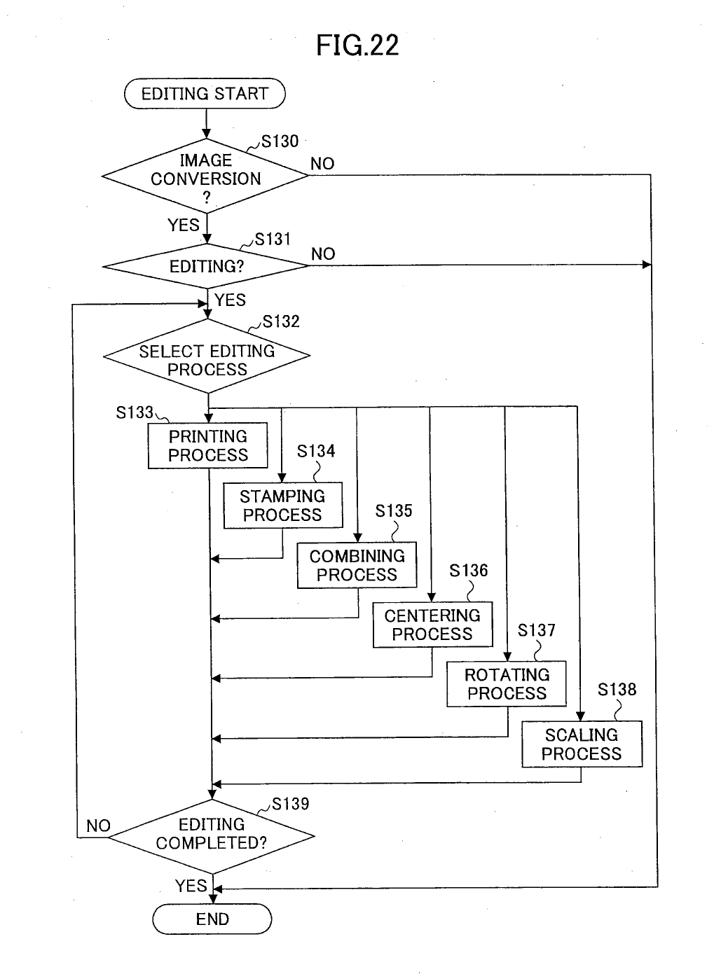

FIG. 22 is a flowchart illustrating exemplary process steps of an editing process of the image conversion process of FIG. 11.

First, a determination is made as to whether image conversion is to be performed on image data (S130). If setting information of the image data indicates that no image conversion is to be performed (S130, NO), the process is ended. If it is determined that image conversion is to be performed (S130, YES), a determination is made as to whether an editing process is to be performed (S131), and if no editing process is to be performed (S131, NO), the process is ended. If it is determined that an editing process is to be performed (S131, YES), an editing process is selected (S132).

In the present example, a printing process (S133), a stamping process (S134), a combining process (S135), a centering process (S136), a rotating process (S137), or a scaling process (S138) may be selected, and the selected editing process may be performed.

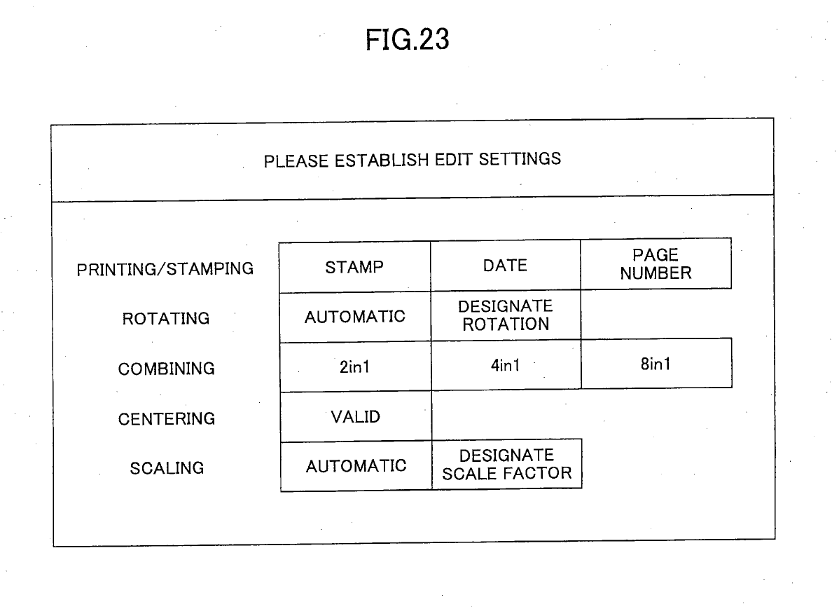

FIG. 23 illustrates an exemplary edit setting screen. In the present example, an editing function of the image processing apparatus 1 is selected to edit image data for a projector. For example, a rotation angle of the image data or the scale factor for the image data may be designated. It is noted that in the case of performing the optimization process, the rotation angle and the scale factor are automatically established. For example, in the case where the initial setting value for the resolution of the projector is 200 dpi and the resolution of the input image at the image processing apparatus is established at 600 dpi, the scale factor is automatically established at 33.3%. As for the image rotating process, the image rotation angle is automatically adjusted so that an input image that is upside down may be displayed in the correct orientation.

Referring back to FIG. 22, in step S139, a determination is made as to whether settings have been established for all the edit processes. If settings are not yet established for all the edit processes (S139, NO), the process goes back to step S132 and another edit process is selected. If settings have been established for all the edit processes (S139, YES), the edit setting process is ended.

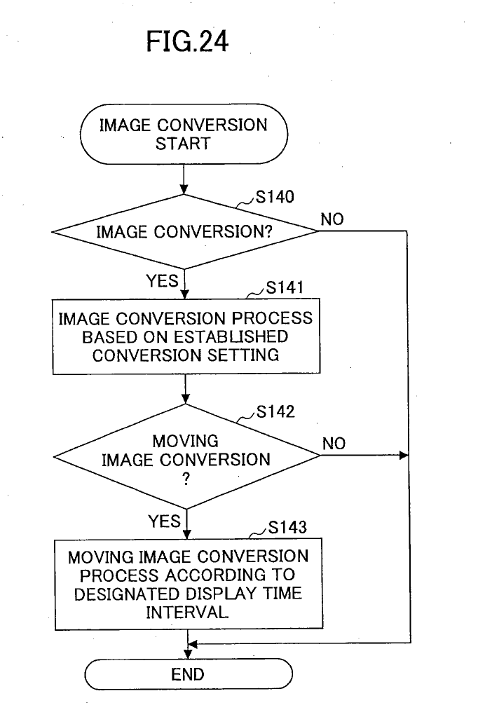

FIG. 24 is a flowchart illustrating image conversion of the image conversion process of FIG. 11.

First, a determination is made as to whether image conversion is to be performed on image data (S140), and if no image conversion is to be performed (S140, NO), the process is ended. If it is determined that image conversion is to be performed (S140, YES), a corresponding image conversion process is performed based on the established conversion settings (S141). Then, a determination is made as to whether a moving image conversion is to be performed (S142). If no moving image conversion is to be performed (S142, NO), the process is ended. If a moving image conversion is to be performed (S142, YES), the image data is converted into a moving image based on the designated display time interval (sec) (S143).

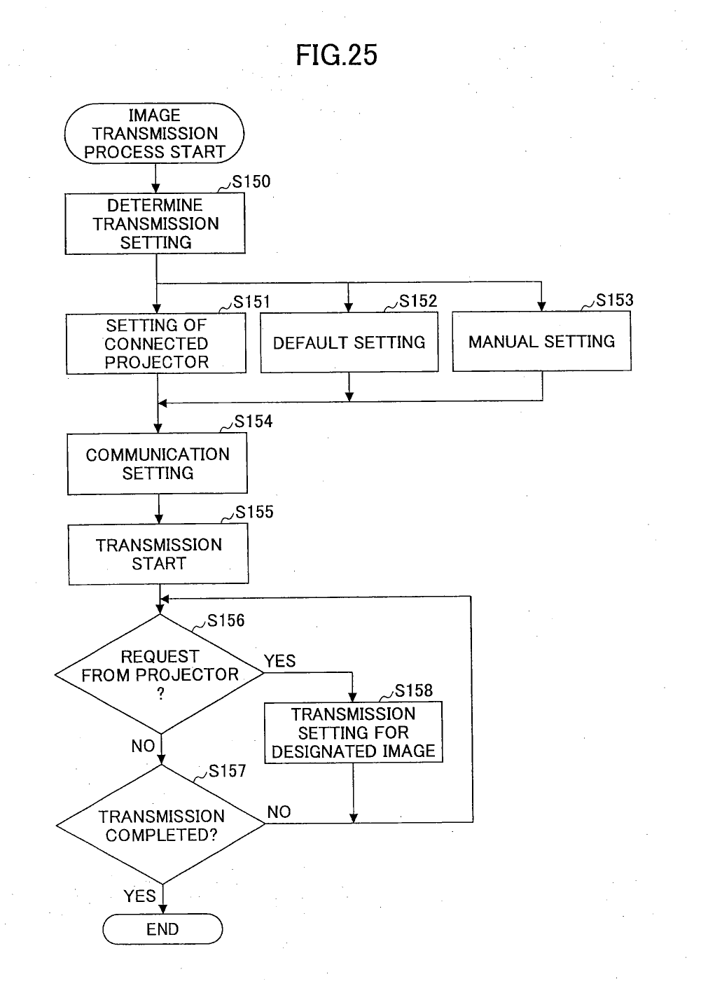

FIG. 25 is a flowchart illustrating an image transmission process.

First, the transmission settings are determined (S150). That is, a determination is made as to whether the transmission settings correspond to those established at the projector (S151), default settings of the image processing apparatus (S152), or transmission settings that are established manually (S153), and communication settings are established based on the determined transmission settings (S154). Then, image data transmission is started based on the established communication settings (S155). During the image data transmission, a determination is made as to whether an image data transmission request for desired image data has been issued from the projector 2 (S156). If there is no transmission request from the projector 2 (S156, NO), a determination is made as to whether transmission of all the image data has been completed (S157). If there is image data that has not yet been transmitted (S157, NO), the process goes back to step S156 where image data transmission is performed while a transmission request from the projector 2 is monitored. If there is a transmission request from the projector 2 (S156, YES), the transmission setting is established for transmitting the image data designated in the transmission request and the image data transmission process is continued (S158). When image data transmission of all the image data has been completed (S157, YES), the process is ended.

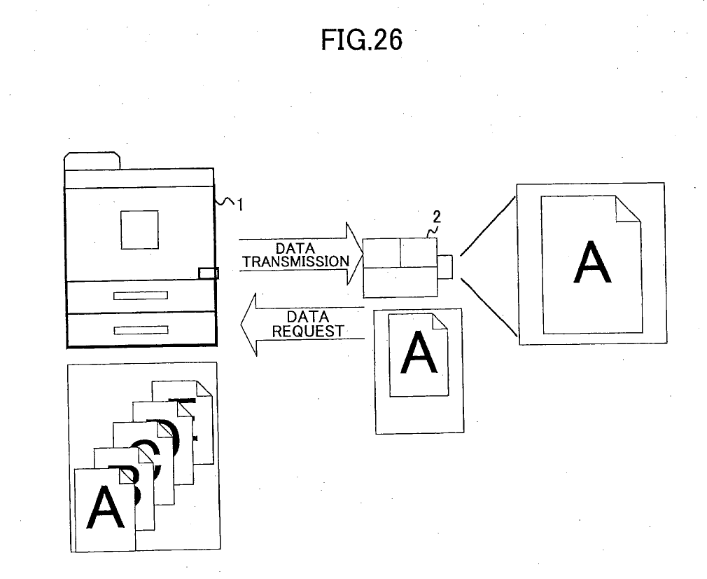

FIG. 26 illustrates an exemplary case of transmitting image data one page at a time.

In the present example, a series of image data are transmitted one page at a time. In a case where there is a transmission request for a designated page from the projector 2, image data transmission of the pages preceding the designated page may be skipped and image data of the designated page may be transmitted.

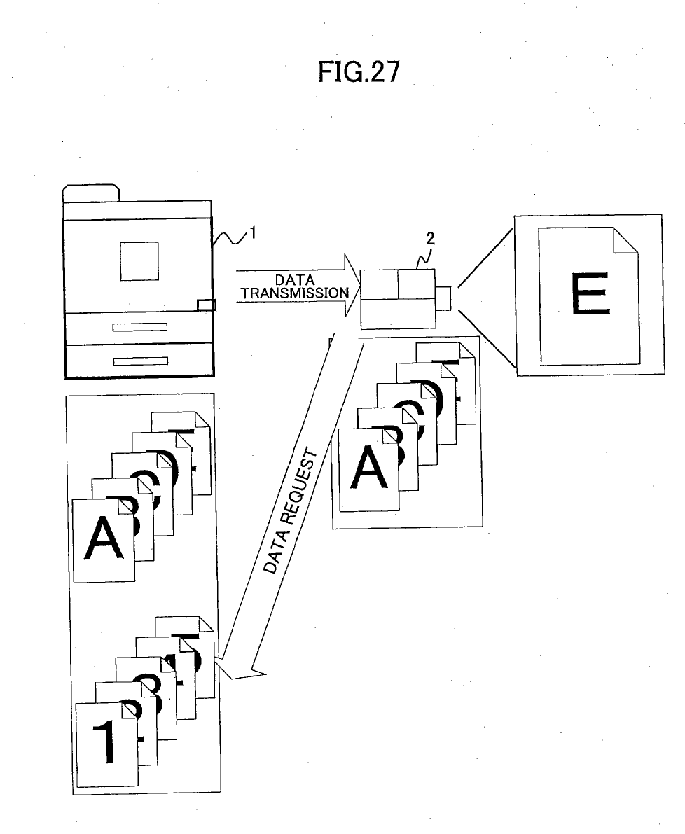

FIG. 27 illustrates an exemplary case of transmitting image data in document units.

In the present example, image data of a document is transmitted all at once to the projector 2, and the projector 2 may receive the transmitted image data, store the image data, and divide the image data into multiple pages. In the present example, the image data may also be transmitted in file units.

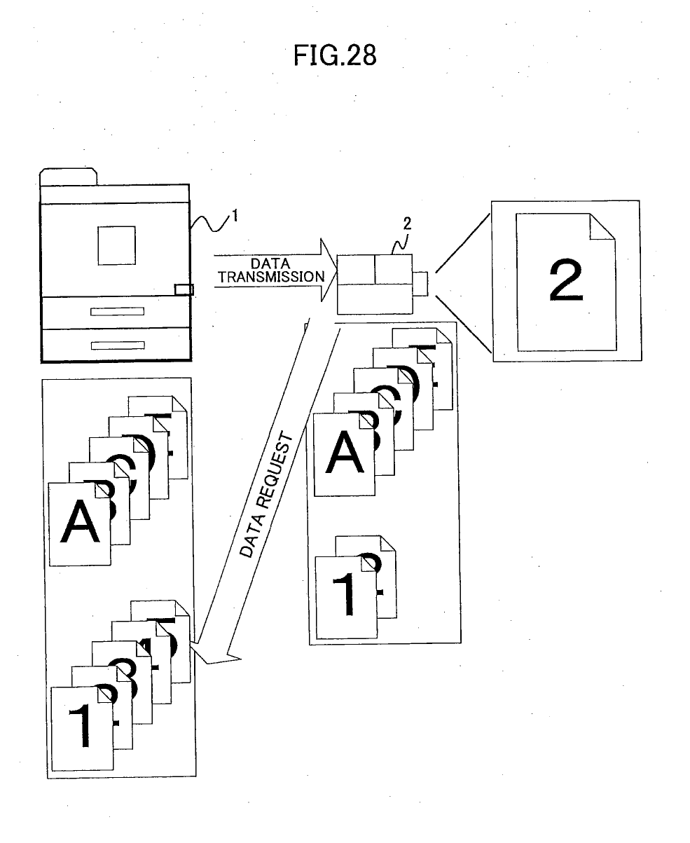

FIG. 28 illustrates an exemplary case of transmitting image data of all selected documents.

In the present example, image data of all selected documents are transmitted from the image processing apparatus 1 to the projector 2. The projector 2 stores a part or all of the transmitted image data that can be accommodated within its memory and displays the stored image data. The part of the transmitted image data that could not be accommodated within the memory of the projector 2 may be transmitted from the image processing apparatus 1 when there is a transmission request for such image data from the projector 2. The projector 2 may sequentially delete image data stored within its memory to store newly acquired image data. It is noted that the manner of deleting the image data stored in the memory of the projector 2 may be established at the projector 2. For example, image data that is stored earlier may be deleted, or image data that has been stored most recently may be deleted to store the newly acquired image data.

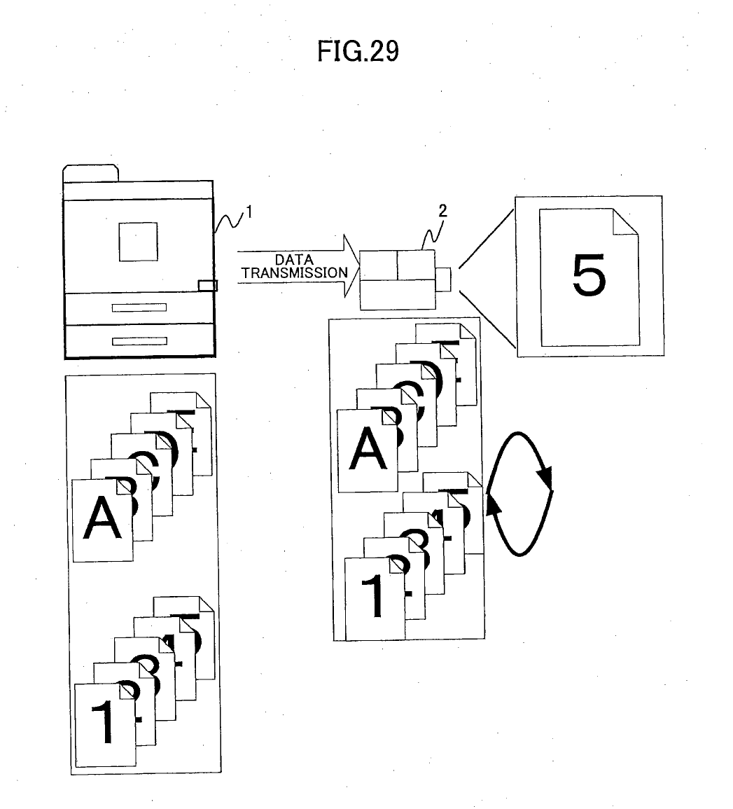

FIG. 29 illustrates an exemplary case of transmitting image data according to the specification information such as memory capacity of the projector 2.

In the present example, image conversion is performed on image data to be transmitted so that all of the image data transmitted from the image processing apparatus 1 may be accommodated within the memory of the projector 2. In this case, all of the image data may be transmitted to the projector 2, and the projector 2 may divide the image data into separate pages and perform other processes on the image data.

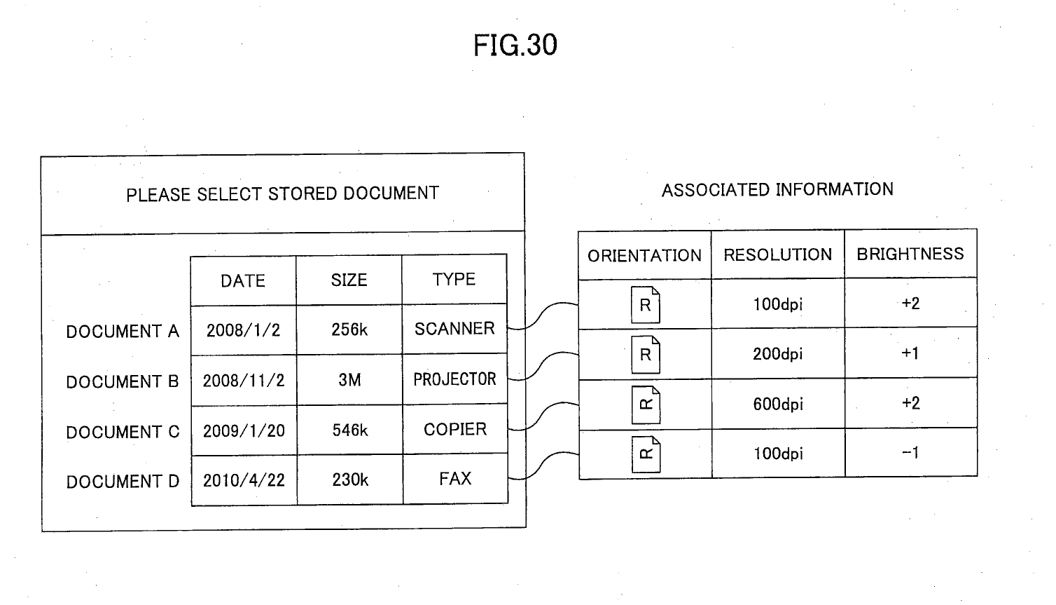

FIG. 30 illustrates an exemplary setting screen for selecting a stored document and transmitting image data of the selected document.

In the present example, the image processing apparatus 1 stores image data of documents A-D in association with their characteristic information that are established according to the manner in which the image data of the respective documents are input. Thus, when transmitting a selected document to the projector 2, the image data of the selected document may be converted into optimized image data for the display characteristics of the projector 2 based on the characteristic information of the selected document and the optimized image data may be transmitted to the projector 2. For example, when the selected document corresponds to a document obtained from the projector 2, the document may be transmitted without performing image conversion or the document may be re-converted and transmitted to the projector 2.

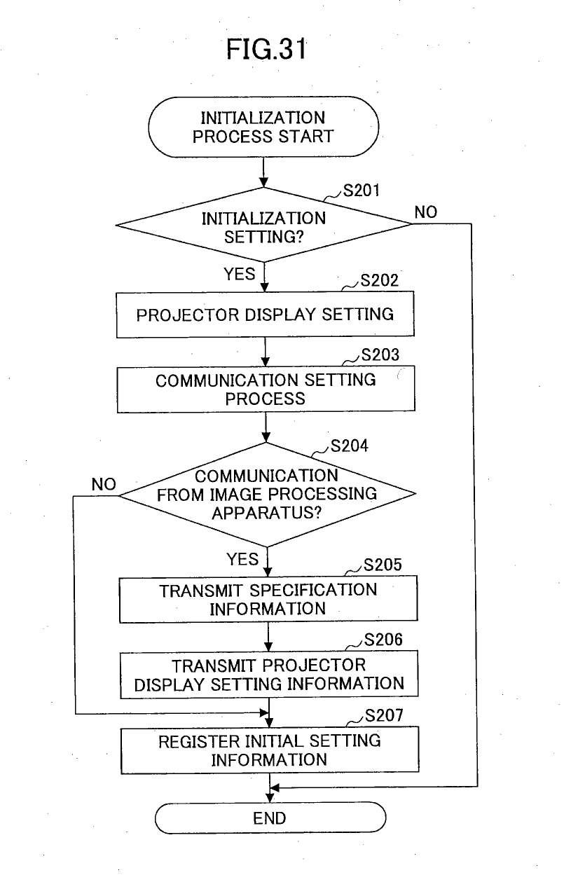

FIG. 31 is a flowchart illustrating exemplary process steps of the initialization process of the projector 2.

In the initialization process of the projector 2, first, a determination is made as to whether initialization is to be performed (S201), and if initialization is to be performed (S201, YES), a display setting of the projector 2 is established (S202). For example, the projector 2 may be configured to receive and display image data one page at a time, receive and display image data in document units, receive and display image data of all documents, or limit the number of pages to be received according to the memory capacity of the projector 2. Then, the projector 2 performs a communication setting process (S203). For example, the projector 2 may determine a communication status with an external apparatus that is connected to the projector 2 via a communication network. Then, the projector 2 determines the communication status with the image processing apparatus 1 (S204), and if communication can be established with the image processing apparatus 1 (S204, YES), a transmission process for transmitting the specification information of the projector 2 is performed (S205). Then, display setting information of the projector 2 is transmitted (S206), and initial setting information is registered (S207). If it is determined in step S201 that no initialization process is to be performed (S201, NO), the process is simply ended. Also, if it is determined in step S204 that communication with the image processing apparatus 1 cannot be established (S204, NO), the process proceeds to step S207 where initial setting information is registered.

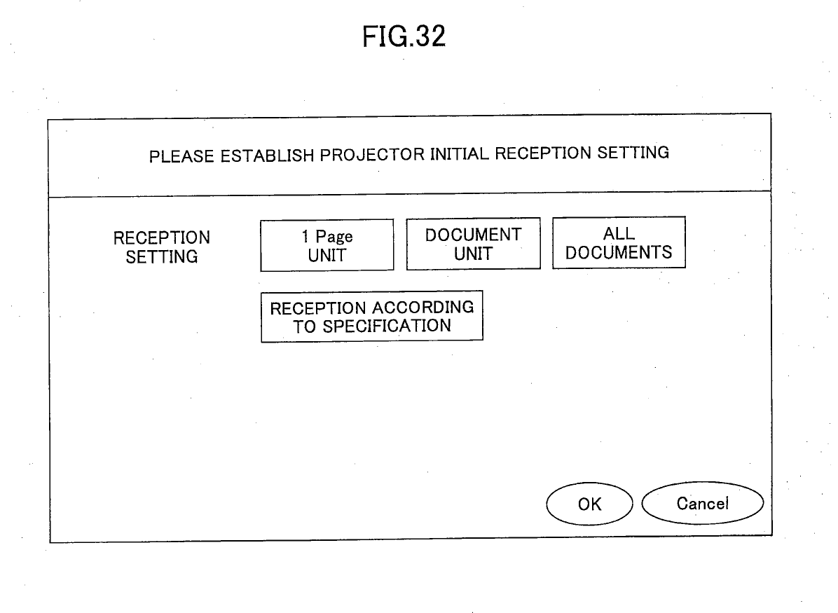

FIG. 32 illustrates an exemplary initial setting screen for the projector 2.

In the present example, an initial setting relating to reception operations of the projector 2 may be selected from “1 page unit,” “document unit,” “all documents,” or “reception according to specification.” The information on the selected reception setting is transmitted to the image processing apparatus 1.

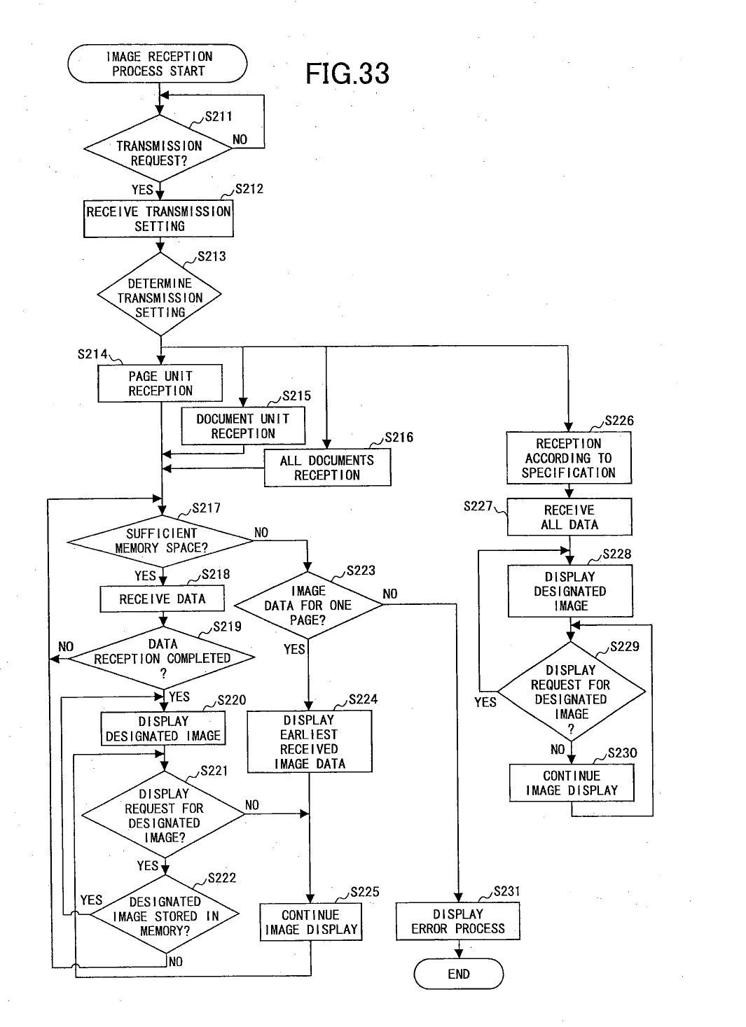

FIG. 33 is a flowchart illustrating exemplary process steps of a reception process of the projector 2.

In the reception process of the projector 2, first, a determination is made as to whether there is a transmission request from the image processing apparatus 1 (S211). If there is a transmission request from the image processing apparatus 1 (S212, YES), the projector 2 receives transmission setting information from the image processing apparatus 1 (S212) and determines the transmission setting (S213). In the present example, a determination is made as to whether the transmission setting corresponds to page unit transmission (S214), document unit transmission (S215), all document transmission (S216), or transmission according to specification (S226), and the reception setting is established according to the determined transmission setting. In the case where the transmission setting corresponds to page unit transmission, document unit transmission, or all documents transmission, a determination is made as to whether there is sufficient memory space (S217). If there is sufficient memory space (S217, YES), the projector 2 receives image data from the image processing apparatus 1 (S218).

Then, a determination is made as to whether image data reception has been completed (S219). If reception has not been completed (S219, NO), the process goes back to step S217. If image data reception has been completed (S219, YES), the projector 2 displays an image designated by a user (S220). Then, a determination is made as to whether there is a display request for a designated image from a user (S221). If there is a display request for a designated image (S221, YES), a determination is made as to whether the designated image is stored in the memory (S222). If the designated image is stored in the memory (S222, YES), the process goes back to step S220 and the projector 2 displays the designated image. If the designated image is not stored in the memory (S222, NO), the process goes back to step S217 to determine whether there is sufficient memory space to store the designated image. If there is not display request for a designated image in step S221, the image display is continued (S225) and the process goes back to step S221 to determine whether there is a display request for a designated image.

If it is determined in step S217 that there is not enough memory space, a determination is made as to whether image data amounting to one page is stored in the memory (S223). If image data amounting to one page is stored in the memory (S223, YES), image data stored in the memory that was received the earliest is displayed (S224). Then, the image display is continued (S225), and the process proceeds to step S221 to determine whether there is a display request for a designated image. If it is determined in step S223 that image data stored in the memory does not amount to image data of one page (S223, NO), this means that the transmitted image data cannot be stored in the memory so that a display error process is performed (S231) and the image reception process is ended.

If it is determined in step S213 that the transmission setting corresponds to transmission according to the memory specification of the projector (S226), the projector 2 receives all image data to be transmitted (S227) and displays an image designated by the user (S228). Then, a determination is made as to whether there is a display request for a designated image from the user (S229), and if there is such a request (S229, YES), the process goes back to step S228 to display the designated image. If there is no display request for a designated image (S229, NO), the image display is continued (S230), and the process goes back to step S229 to determine whether there is a display request for a designated image.

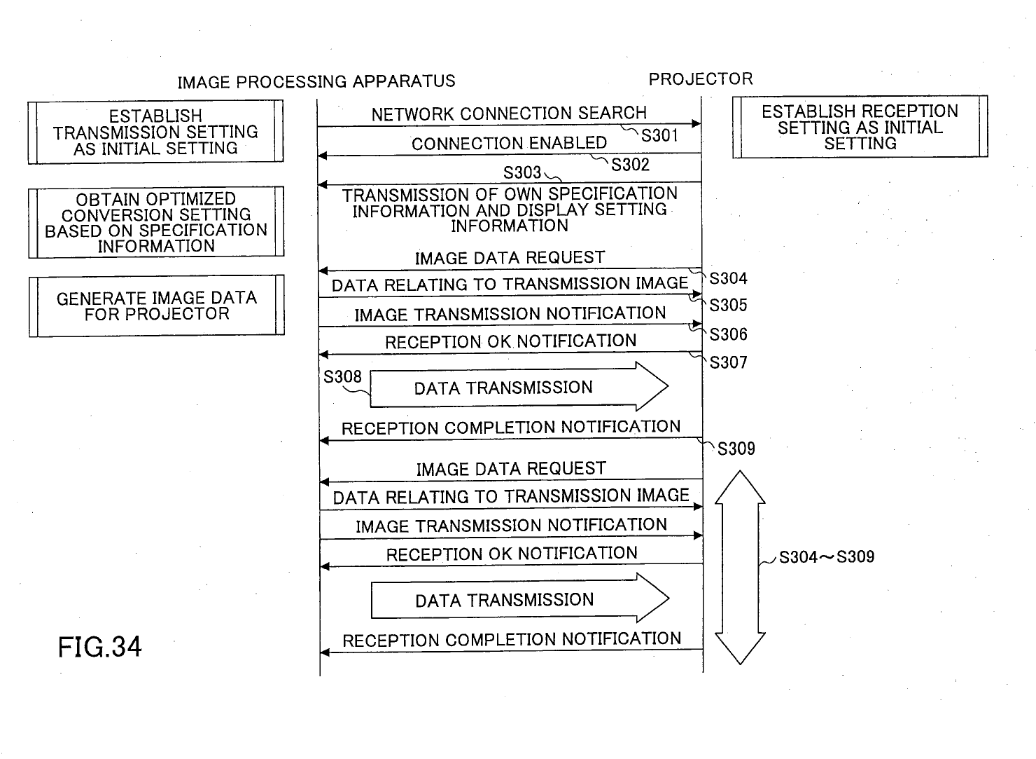

FIG. 34 is a sequence chart illustrating image display process operations between the image processing apparatus 1 and the projector 2.

The image processing apparatus 1 and the projector 2 establish the above-described initial settings relating to image display upon performing startup initialization processes. Then, the image processing apparatus 1 searches for a network connection (S301), and in turn, the projector 2 issues a response indicating that connection can be established (S302). Then, the projector 2 transmits specification information and display setting information to the image processing apparatus 1 (S303).

The image processing apparatus 1 receives the specification information and the display setting information of the projector 2, establishes conversion settings based on the received specification information to enable conversion of image data into an optimal form for display at the projector 2, and converts image data to be transmitted to the projector 2 based on the established conversion settings to generate image data for the projector.

When the projector 2 issues an image data transmission request (S304), the image processing apparatus 1 transmits data relating to the transmission image such as the number of pages and/or the number of documents (S305) and sends an image transmission notification to the projector 2 (S306). Upon receiving an image data reception OK notification from the projector 2 (S307), the image processing apparatus 1 transmits the requested image data (S308). When the image data transmission is completed, the projector 2 sends a reception completion notification to the image processing apparatus 1 (S309). The above process steps S304-S309 of the image data transmission process may be repeated as desired to enable image display by the projector 2 according to its display settings.

According to an aspect of the present invention, in connecting an image processing apparatus 1 to a display apparatus such as the projector 2 to have the display apparatus display image data stored in the information processing apparatus 1, the image processing apparatus 1 converts image data based on characteristic information of the display apparatus to generated image data that is optimized for display by the display apparatus. The image processing apparatus then transmits the converted image data to the display apparatus so that the image data may be accurately displayed by the display apparatus without making any readjustments on the image data.

Further, the present invention is not limited to these embodiments, and numerous variations and modifications may be made without departing from the scope of the present invention.

The present application is based on and claims the benefit of priority to Japanese Patent Application No. 2012-062702 filed on Mar. 19, 2012, the entire contents of which are hereby incorporated by reference.

What is claimed is:

1. An image processing system comprising:
an image processing apparatus that transmits image data to be displayed by a display apparatus, the image processing apparatus including a processing side memory unit that stores characteristic information of the image processing apparatus and the display apparatus, an image conversion process unit that converts input image data into converted image data that is optimized according to a display characteristic of the display apparatus based on the characteristic information, and a processing side transmission process unit that transmits the converted image data to the display apparatus; and
the display apparatus that includes a display side reception process unit that receives the converted image data transmitted from the image processing apparatus, and an image display unit that displays the received image data.

2. The image processing system as claimed in claim 1, wherein
the image processing apparatus includes an editing unit that edits the input image data upon converting the input image data.

3. The image processing system as claimed in claim 1, wherein
the display apparatus includes a display side transmission process unit that transmits display setting information relating to image display to the image processing apparatus; and
the processing side transmission process unit transmits the converted image data to the display apparatus based on the display setting information received from the display apparatus.

4. The image processing system as claimed in claim 1, wherein
the image conversion process unit is configured to perform a moving image conversion process based on the converted image data.

5. The image processing system as claimed in claim 1, wherein
the image conversion process unit is configured to perform a re-conversion process on the converted image data based on different characteristic information of a different display apparatus.

6. An image processing apparatus that processes image data to be displayed by a display apparatus, the image processing apparatus comprising:
a processing side memory unit that stores characteristic information of the image processing apparatus and the display apparatus;
an image conversion process unit that converts input image data into converted image data that is optimized according to a display characteristic of the display apparatus based on the characteristic information; and
a processing side transmission process unit that transmits the converted image data to the display apparatus.

7. A display apparatus that displays image data processed by an image processing apparatus, the display apparatus comprising:
a display side transmission process unit that transmits characteristic information of the display apparatus and display setting information relating to image display of the display apparatus to the image processing apparatus;
a display side reception process unit that receives image data transmitted from the image processing apparatus based on the display setting information; and
an image display unit that displays the received image data.
